(19) United States
(12) Patent Application Publication
(10) Pub. No.: US 2008/0152893 A1
(43) Pub. Date: Jun. 26, 2008

(54) Process for Producing Gas-Tight and Temperature-Stable Modules with Ceramic Hollow-Fibre or Capillary Membranes

(75) Inventors: Norbert Stroh, Magstadt (DE); Thomas Schiestel, Stuttgart (DE)

Correspondence Address: DICKSTEIN SHAPIRO LLP, 1177 AVENUE OF THE AMERICAS (6TH AVENUE), NEW YORK, NY, 10036-2714, US

(73) Assignee: Fraunhofer-gesellschaft zur Forderung der Angewandten Forschung E.V., Munchen (DE)

(21) Appl. No.: 11/817,138

(22) PCT Filed: Jan. 30, 2006
(86) PCT No.: PCT/EP06/00766

§ 371 Date: Feb. 27, 2008

(30) Foreign Application Priority Data
Feb. 26, 2005 (DE) 10 2005 008 900.3

(51) Int. Cl. B32B 5/02; B29C 67/00; B29C 35/00

(52) U.S. Cl. 428/313.9; 264/250; 264/603

(57) ABSTRACT

The present invention relates to modules comprising hollow fiber or capillary membranes, a mold and embeddings made of potting compounds, which are referred to as “pottings” and which embed the hollow fiber or capillary membranes into a mold in a gas-tight and temperature-stable manner, and to methods for producing such hollow fiber or capillary membrane modules.

The present invention relates to modules comprising ceramic hollow fiber or capillary membranes therein and to methods for producing these modules.

The present invention is primarily used in filtration and separation technologies. In these technologies, among other things, organic or inorganic membranes in the form of modules are used as separation tools for the filtration of liquids as well as the separation of gases. The hollow fiber or capillary membrane modules can be used for the separation and/or purification of gases and vapors, particularly in high-temperature applications, as well as for the filtration of liquids in micro-filtration, ultra-filtration and nano-filtration, and as membrane reactors.

Today, not only organic polymer materials, but increasingly also inorganic materials are used to produce membranes. Particular emphasis is placed on the development of membranes from ceramic materials. These materials have a number of advantages, such as increased chemical inertness, high temperature stability, as well as excellent mechanical strength. Filtration modules made of ceramic materials have been used for quite some time.

Recently, ceramic hollow fiber and capillary membranes are also being used. Compared to other membrane geometries, these offer considerable advantages.

Integration in modules plays an important role in the use of these ceramic hollow fiber and capillary membranes. Not only must such membrane modules should be stable with respect to chemicals and temperatures, but for certain types of applications they must also be sealed in a gas-tight manner. The integration of hollow fiber membranes in modules may be achieved by embedding, also referred to as potting, using a sealing compound, also referred to as a potting compound, or a free-flowing bonding material.

Potting materials and potting techniques must be adapted for the production of chemically and thermally stable modules comprising ceramic hollow fiber or capillary membranes.

In a preferred embodiment, a suitable material for use as a potting compound is therefore the same ceramic material of which the ceramic hollow fiber membranes are made. Because of the ideal compatibility, a potting compound made of ceramic lends itself to this application. If used by itself in a single layer however, this compound can generally not be sintered in a gas-tight manner, since the ceramic hollow fiber membranes are also irreversibly changed.

A method for producing a hollow fiber membrane module is known from EP 0 941 759 A1, wherein the sintered hollow fibers are introduced into a mold and are potted in this mold with a potting compound. The potting compound used is a compound comprising ceramic, which is subsequently hardened or solidified in a suitable temperature step. The mold for receiving the hollow fibers is configured as a perforated plate, which is then fitted, with the fibers potted therein, into a housing. However, the production of a hollow fiber module according to the method in this published prior art is difficult because the sintered hollow fibers have a high propensity to break, which is inherent to ceramics. Because it is not easy to handle the hollow fibers, insertion into the apertures of the mold that is configured as a perforated plate is difficult, and may result in breakage of the hollow fibers.

Another method for producing a hollow fiber module is known from EP 0 938 921 A1. In this method, a bundle of hollow fibers is introduced into a cylindrical mold and potted in this mold by subjecting the potting compound to ultrasound. However, this method can also easily result in breakage of the hollow fibers.

Another method for producing a hollow fiber or capillary membrane module is known from EP 1 370 348 B1. In this method, hollow fibers or capillaries made of a ceramic or a material comprising ceramic are introduced, in the unsintered state, into a mold structured for receiving hollow fibers or capillaries, and are potted in the mold with a single-layer of potting compound. However, the potting compound described in this published prior art does not enclose the embedded hollow fiber or capillary membranes in a gas-tight manner. In order to achieve the gas tight potting required for proper functioning with this method, either an additional coating must be applied in a further complex step or the module must be integrated into a complex device using sealing elements.

The underlying technical problem of the present invention is, therefore, that of providing modules made of ceramic hollow fiber or capillary membranes in a simple manner, the membranes being more temperature-stable, easy to handle, mechanically stable and/or gas-tight.

This technical problem is solved by a module, a method for producing such a module, and by a device, according to the claims. The production of particularly gas-tight and mechanically stable hollow fiber and capillary membrane modules can be considerably simplified by the proposed module design and the proposed method.

The present invention solves the underlying technical problem, in particular, by providing a module comprising a) a mold, b) at least one hollow fiber or capillary membrane introduced therein, wherein according to the invention this membrane is preferably made of a ceramic or a material comprising ceramic, as well as c) at least one potting configured as a gas-tight bond between the mold and the at least one hollow fiber or capillary membrane, the potting comprising at least three layers made of at least two different potting compounds. Furthermore, the invention solves the underlying technical problem by a method for producing such a module.

A hollow fiber or capillary membrane module according to the invention or an inventive device comprising such a module can be used in many technical fields of application. Examples include the drying or humidification of air (climate control technology), catalysis, purification of hot gases, separation of gases, pervaporation, vapor permeation, heterogeneous catalysis, use in membrane reactors, in heat exchangers, in contactors, in fuel cells, as prefilters for purification, the filtration of corrosive media such as hot acids and lyes or solvents, the filtration of abrasive, toxic, microbiologically or otherwise contaminated fluids as well as the processing of emulsions.

In the context of this invention, the term “hollow fiber membrane” shall mean a tubular membrane body with an external diameter in the range from approximately 10 μm to 0.50 mm.

In the context of this invention, the term “capillary membrane” shall mean a tubular membrane body with an external diameter in the range from approximately 0.51 mm to 3 mm.

However, it shall be noted that for special applications, membranes with different external diameters can be integrated into a module. The hollow fiber and capillary membranes can take on any shape known from the state of the art.

In the context of the present invention, “ceramic hollow fiber or capillary membranes” shall be interpreted as hollow fiber or capillary membranes being made of, being substantially made of or comprising at least one ceramic or one material comprising ceramic. The at least one hollow fiber or capillary membrane can be provided, as is known, as a green fiber or in the green state. The membrane can be obtained by spinning or extruding inorganic or metal-organic compounds, such as polymer precursors or inorganic suspensions comprising binders, aqueous solutions, salts or sols/gels filled with powder. A hollow fiber or capillary membrane produced in this way is flexible and easy to handle in the green state. According to the invention, the at least one hollow fiber or capillary membrane is preferably used in a sintered or pyrolized state. Ceramic firing, also referred to as sintering, crucially influences the properties of the resulting ceramic hollow fibers or capillaries. In a successful sintering process, excellent mechanical stability is achieved, while the open pores are maintained at the same time. In the sintered state, the at least one hollow fiber or capillary membrane is made of, is substantially made of or comprises materials selected from the group consisting of oxide materials such as ZrO₂, TiO₂, α-Al₂O₃, γ-Al₂O₃, 3Al₂O₃.2SiO₂ (mullite), MgAl₂O₄ (spinel), SiO₂, perovskites, hydroxylapatite, zeolites, non-oxide substances such as SiBNC, SiC, BN, Si₃N₄, C, as well as of metals such as copper, titanium, iron, special steels or transition metal alloys, and combinations thereof. This list is of course not exhaustive. A person skilled in the art is familiar with suitable materials for producing ceramic hollow fibers or capillaries. The ceramic may also be coated with ceramics, such as spinel nanoparticles to adjust the pore size, or with metals, such as Pd alloys. The hollow fibers may be porous or impervious.

The at least one ceramic hollow fiber or capillary membrane can be introduced into the mold either in the unsintered state or it can already have been be sintered. In a preferred embodiment, the at least one ceramic hollow fiber or capillary membrane is introduced into the mold in the sintered state. According to the invention, the number of ceramic hollow fiber or capillary membranes introduced into the mold can be one, a few, for example 2 to 10, several such as 11 to 999, or many, for example 1,000 to 100,000.

According to the invention, the at least one ceramic hollow fiber or capillary membrane is preferably porous, particularly microporous or nanoporous, however it may also be gas-impermeable.

In the context of the present invention, “mold” shall mean a structured closed, semi-closed or open mold. Exemplary embodiment variants of this mold are cylindrical, oval, box-shaped, fluted or corrugated bodies or star-shaped bodies, which due to their geometry comprise recesses for receiving the fibers or capillaries. According to the invention, the mold is preferably cylindrical. According to the invention, the mold may comprise a bore through which the potting compounds can be poured in. The mold is used to dispose and retain the membranes in a device, for example a filtration device, particularly in a module, such as a filter module, and positions the membranes such that they can function as intended. In particular, it is also used as a connecting element for feeding and discharging fluids and/or gases. The mold may, for example, be made of a porous, sealed or impervious ceramic or other inorganic materials, such as metal or glass. It is preferred that the receiving mold have the same or similar coefficient of thermal expansion as the hollow fibers or capillaries and the potting material. In this way, stresses during production as well as during later use of the module at high temperatures are prevented. The mold is part of the hollow fiber or capillary membrane module and is shaped such that the hollow fibers or capillaries can be received therein. The placement of the hollow fibers or capillaries into the mold may be performed manually or by machine.

In the context of the present invention, the term “module” shall mean a component comprising at least one ceramic hollow fiber or capillary membrane, at least one embedding or potting and a mold.

In the context of the present invention, a “potting” shall be interpreted as a bonding material in the bonding region of the membrane and mold, the material being introduced into the mold and serving to fix a membrane in the mold.

In the context of the invention, the term “potting” shall particularly mean the embedding or fixation, with a potting compound, of at least one longitudinal section of at least one hollow fiber or capillary membrane in a mold.

The casting compound, which is also referred to as the potting compound, is the bonding material itself. According to the invention, the potting compound may be a suspension, particularly an aqueous suspension, which is known to a person skilled in the art as a slip. After introducing and shaping the potting compound in the mold comprising the membrane, the compound is hardened or solidified so that a hollow fiber or capillary membrane module is produced, which can be introduced into a housing and used in technical systems. The solidification of the potting compound can be performed, for example, by means of a thermal processing step. If a ceramic material is used as the potting compound, the sintering of the hollow fibers or capillaries and the hardening of the potting compound can be performed in the same thermal processing step. This technique is referred to as cofiring.

According to the invention, the potting compounds can be made of different materials. In a preferred embodiment, the materials used have a coefficient of expansion that is similar or identical to that of the ceramic hollow fiber or capillary membranes. It is preferable that the difference in the expansion coefficients be no greater than 5×10⁻⁶ K⁻¹, preferably no greater than 1×10⁻⁶ K⁻¹, with a higher thermal expansion coefficient for the fiber or capillary material being more readily tolerated than the reverse.

The expansion coefficients of known materials for the potting compound or for the hollow fibers or capillaries are approximately 8×10⁻⁶ K⁻¹ for Al₂O₃, approximately 10×10⁻⁶ K⁻¹ for ZrO₂ (Y₂O₃-stabilized), approximately 0.5×10⁻⁶ K⁻¹ for SiO₂, approximately 8-10×10⁻⁶ K⁻¹ for TiO₂ and approximately 4.5×10⁻⁶ K⁻¹ for SiC. From these examples it is apparent that numerous materials and material combinations are available, which meet the above condition of a small difference in thermal expansion coefficients.

Furthermore, in a preferred embodiment according to the invention, it is provided that a material, which is to be used as the potting compound, is chemically inert with respect to the potted ceramic hollow fiber or capillary membranes in the relevant temperature range. These properties of the potting compound minimize thermal stresses in the module.

According to the invention, the at least one potting therefore comprises a plurality of, preferably three layers made of at least two different potting compounds. According to the invention, it is preferable that the at least one potting be formed from two exterior layers and one interposed intermediate layer.

It is preferable that at least one of the at least three layers be made of a material that is compatible with the material of the at least one hollow fiber or capillary membrane, which is to say preferably with a ceramic or a material comprising ceramic, or is made of this material. In the context of the present invention, a “compatible” material shall mean a material with properties similar to the properties of the comparative material with respect to chemistry and expansion.

It is preferable that at least one of the at least three layers be made of the same ceramic or material comprising ceramic as the at least one hollow fiber or capillary membrane, or is made of this material.

Surprisingly, it has been found that it suffices to combine one layer having a certain composition, for example a glass layer, with two further layers made of at least one different potting compound, and particularly to enclose it between two ceramic layers, in order to obtain a gas-tight potting. The structure of the potting with at least three layers enables the simultaneous sintering of two or more pottings, which an inventive module preferably comprises according to the invention. The structure of the potting with at least three layers also prevents the potting compound of the intermediate layer, which according to the invention is preferably made of glass or metal, from being insufficiently incorporated in the exterior layer to be sealed as a result of capillary forces.

According to the invention, it is particularly preferred that, in addition to two or more ceramic layers, a layer, which is preferably made of glass or metal, be inserted as an intermediate layer. According to the invention, it is preferable that this metal or glass layer have a metal or glass softening point that is clearly below the sintering temperature of the employed ceramic and clearly above the future operating temperature. In addition, it is preferable according to the invention that the employed glass or metal thoroughly wet the ceramic potting compound and that the viscosity of the glass or metal enables smaller pores and larger cracks to be sealed during sintering.

The invention therefore relates to a module, comprising a) a mold, b) at least one, and preferably a plurality of or many hollow fiber or capillary membranes embedded therein, preferably parallel to one another or in twisted or braided form, as well as c) at least one potting formed as a gas-tight bond between the mold and the at least one hollow fiber or capillary membrane, the potting comprising at least three layers made of at least two different potting compounds. In a preferred embodiment, it is provided that one, and preferably both faces of the at least one hollow fiber or capillary membrane are connected to a mold providing feed and discharge lines for fluids and/or gases, particularly connected by the sintering of the potting compound.

According to the invention, a module is provided, comprising at least one hollow fiber or capillary membrane, wherein the at least one hollow fiber or capillary membrane is made of, is substantially made of, or comprises a ceramic or a material comprising ceramic, further comprising a mold, wherein the at least one hollow fiber or capillary membrane is introduced into or connected to the mold, and further comprising at least one potting, wherein the at least one potting comprises at least three layers and wherein the layer sequence is composed of at least two potting compounds having different compositions. In a preferred embodiment, the at least one potting is disposed such that it completely encloses at least one hollow fiber or capillary membrane in a defined longitudinal region and in that it completely fills in the space between the at least one hollow fiber or capillary membrane and the mold in this longitudinal region, thus embedding the membrane in the mold, so that the at least one hollow fiber or capillary membrane is connected or bonded to the mold in a gas-tight manner, and so that, as a result of the at least one potting, a longitudinal region of the at least one hollow fiber or capillary membrane not covered by the potting is spatially separated from the lumina of the at least one hollow fiber or capillary membrane in a gas-tight manner, the lumina preferably being open.

In a further preferred embodiment according to the invention, the potting comprises a plurality of layers made of different potting compounds. In a particularly preferred embodiment, the at least one potting comprises two exterior layers and an interposed intermediate layer. According to the invention, the at least one potting may comprise three layers made of a total of three different potting compounds. In a preferred embodiment of the invention, the at least one potting comprises three layers made of a total of two different potting compounds, wherein the two exterior layers are made of the same potting compound. In a further preferred embodiment according to the invention, the potting comprises two ceramic exterior layers or two exterior layers comprising ceramic and at least one intermediate layer. In a particularly preferred embodiment according to the invention, two different casting compounds or potting compounds are used, one being made of a ceramic or a material comprising ceramic and the other being made of glass or metal. It is particularly preferred that the two exterior layers be made of a ceramic or a material comprising ceramic and the intermediate layer is made of glass or metal.

According to the invention, the material softening point of the glass or metal used for the intermediate layer is preferably below the sintering temperature of the ceramic or the material comprising ceramic of the two exterior layers and above the operating temperature of the module. In a preferred embodiment according to the invention, the glass or metal used for the intermediate layer thoroughly wets the ceramic or the material comprising ceramic of the at least one of the two exterior layers, which is to say that the ceramic or the material comprising ceramic of the at least one exterior layer has a high wettability for the glass or metal used for the intermediate layer. According to the invention, during the melting or during the sintering, the viscosity of the glass or metal used for the intermediate layer contributes to the sealing of small pores and cracks in at least one of the two exterior layers. According to the invention, it is preferable if the expansion coefficient of the potting compounds of the at least three layers is similar or identical to that of the at least one hollow fiber or capillary membrane. According to the invention, it is preferable if the potting compounds of the at least three layers are chemically inert with respect to the at least one hollow fiber or capillary membrane. According to the invention, the potting compounds of the at least three layers are preferably particulate.

In a preferred embodiment according to the invention, the at least one hollow fiber or capillary membrane is introduced into one potting, at both ends thereof respectively.

In a preferred embodiment according to the invention, a module of the present invention comprises a mold, a plurality of ceramic hollow fiber or capillary membranes and two pottings, one potting being provided at each of the two ends of the ceramic hollow fiber or capillary membrane.

The invention also relates to methods for producing inventive modules.

The invention therefore relates to a method for producing a module, comprising the following steps in the sequence listed: a) introducing at least one hollow fiber or capillary membrane into a mold, b) introducing a first potting compound into the mold, c) shaping a first layer of a potting from the first potting compound that was introduced, d) introducing a second potting compound into the mold, e) shaping a second layer of a potting from the second potting compound that was introduced, f) introducing a third potting compound into the mold, and g) shaping a third layer of a potting from the third potting compound that was introduced. Optionally, steps f) and g) may be repeated once or multiple times with further potting compounds in order to introduce further layers.

In method according to the invention, the at least one hollow fiber or capillary membrane may be introduced into a mold in the unsintered state, which is to say as a green fiber, or in the sintered state. In a preferred embodiment according to the invention, the at least one hollow fiber or capillary membrane is introduced into the mold in the sintered state. This means that the desired porosity and the pore size of the at least one hollow fiber or capillary membrane was produced by prior sintering.

According to the invention, at least a second potting is preferably introduced and shaped in the mold. According to the invention, it is preferable if all pottings of the module are introduced and shaped using a production method comprising the above-mentioned steps.

A preferred embodiment of the invention is such that, after shaping, the at least one potting layer the layer is allowed to harden. Hardening may either be performed individually for each layer, directly after introducing the respective potting compound and prior to introducing the next potting compound, or the hardening may be performed simultaneously for all layers after introducing the last potting compound. According to the invention, it is preferable to harden all the introduced layers together, after introducing the last potting compound. According to the invention, all introduced pottings may be hardened together or successively.

According to the invention, one layer, preferably the first or outermost layer of the at least one potting, may be joined to a closure. According to the invention, also the potting compound of the first layer, which is to say the outermost layer, of the at least one potting can be introduced as a closure. According to the invention, the material of the closure is selected from ceramic materials, materials comprising ceramic, waxes, polymers, adhesives and combinations thereof.

The hollow fiber or capillary ends used according to the invention may therefore be open or closed by a closure. In the event that a closure is provided, the hollow fiber or capillary ends can be cut off together with the closure after the potting compound has been introduced, shaped and hardened, so that the lumina of the fibers or capillaries are open. Cutting off the capillary or fiber ends with the closure may be performed with a suitable severing method, for example by means of a diamond wire saw, water jet technology or laser cutting technology. According to the invention, it is preferable that, after introducing, shaping and hardening at least one layer, the ceramic closure be removed from all layers of the at least one potting. A closure made of organic materials may be burned off during the sintering process.

For the method for producing the potting, which is to say particularly for introducing and shaping the pottings, various technologies are available and known to persons skilled in the art, for example centrifugal techniques or casting techniques. The potting compounds, which according to the invention are preferably ceramic or glass potting compounds, are introduced as slips, preferably as aqueous slips. According to the invention, the slips used are preferably produced or formed by dispersing particulate potting materials into a fluid, preferably water. After introducing the at least one potting layer, the liquid phase is separated. The liquid phase can be separated, for example, by centrifuging, by applying pressure on the inside or by applying a vacuum on the outside.

In a preferred method according to the invention, the at least three layers of the at least one potting are shaped successively by a centrifugal method.

According to the invention, it is preferable in this method that the first and third potting compounds be made of a ceramic or a material comprising ceramic and the second potting compound be made of glass or metal. According to the invention, a potting compound made of a ceramic or a material comprising ceramic may also comprise small amounts, which is to say up to 20% by weight of glass and/or metal. According to the invention, a potting compound made of glass or metal may also comprise small amounts, which is to say up to 20% by weight of a ceramic or a material comprising ceramic.

In a preferred embodiment, the at least three layers of the at least one potting can be sintered after shaping and after hardening one, two or more, and preferably all layers. According to the invention, the module is preferably sintered in one step. As a matter of course, the sintering can also be performed in two or more steps.

According to the invention, the potting compound, which is preferably made of glass or metal, of the second layer, which is to say the intermediate layer, of the at least one potting completely or partially melts as a result of the sintering operation.

According to the invention, the sintering temperature may preferably correspond to, or be identical to, the material softening point of the material used for the intermediate layer, which is preferably glass or metal. According to the invention, the sintering temperature may preferably exceed the material softening point of the material used for the intermediate layer, which is preferably glass or metal, and may be below the sintering temperature of the ceramic, or the material comprising ceramic, of the at least one hollow fiber or capillary membrane. The sintering temperature, according to the invention, may also correspond to, or be identical with, the sintering temperature of the ceramic or the material comprising ceramic of the at least one hollow fiber or capillary membrane. According to the invention, the sintering temperature ranges from 700° C. to 1500° C., preferably from 1000° C. to 1300° C., with 1050° C. to 1200° C. being particularly preferred.

In a particularly preferred method, the module is sintered in an upright position. In the context of the present invention, an “upright” module shall be interpreted as a module in which the at least one introduced hollow fiber or capillary membrane extends longitudinally parallel to a gravitational force or a centrifugal force. According to the invention, the gravitational force is preferably the earth's gravitation. If an inventive module according to a particularly preferred embodiment comprises at least one hollow fiber or capillary membrane, one mold and two inventive pottings, in such a module, when it is in the upright position, one of the two inventive pottings is disposed in the upper end region of the mold, while the other of the two inventive pottings is formed in the lower end region of the mold.

As a result of the above-described layer structure of an inventive potting, during sintering, the molten potting compound of the intermediate layer is partially incorporated in the ceramic layer disposed beneath, which is to say that between the glass or metal layer and the ceramic layer underneath a bond is created, which according to the invention seals the potting in a gas-tight manner.

According to the invention, a method is preferred in which compaction of the glass or metal used for the intermediate layer of the at least one potting, which is brought about during sintering, produces a hollow space between the intermediate layer and one layer, preferably an exterior layer, of the at least one potting. In the inventive method, it is preferred that, by way of the sintering operation and applied gravitational force, a portion of the glass or metal used for the intermediate layer of the at least one potting is incorporated in the pores of part of the ceramic or the material comprising ceramic of one layer, preferably an exterior layer, of the at least one potting, thus forming a layer having a mixed composition. The above-mentioned hollow space is created in the region from which the glass or metal migrates to the extent that, during sintering, a portion of the glass or metal layer moves into regions of layers having different compositions, particularly layers underneath, and thus form the layer having a mixed composition.

The invention furthermore comprises modules that can be obtained by means of one of the inventive methods.

The invention also relates to devices comprising at least one inventive module as well as a housing. In a preferred embodiment according to the invention, the housing is configured as a metal cartridge. The mold and cartridge are preferably sealed in a gasket-like manner between the lumen side and the exterior of the hollow fibers or capillaries. The cartridge is used to adapt the device to an overall system. It is particularly preferred that the mold and the housing be cylindrical in the inventive device.

Advantageous embodiments are the subjects of the dependent claims. The invention will be explained in more detail with reference to examples provided below and the associated FIGURE.

The FIGURE shows a longitudinal sectional view of an inventive module.

### EXAMPLE

### Module Production

Porous, sintered Al₂O₃ capillary membranes having an external diameter of 1.6 mm and measuring 25 cm in length are used as the hollow fiber or capillary membranes (1). A gas-tight ceramic pipe made of Al₂O₃ having a variable diameter and a length of 25 cm serves as the mold (2). The ceramic potting compound for the exterior layers I (4) and the exterior layers II (6) is a slip made of 80% Al₂O₃ powder and 20% water. The Al₂O₃ powder has an average particle size of 0.5 μm. The potting compound for the intermediate layer (5) is 50% borosilicate glass and 50% water. The borosilicate glass has an average particle size of 5 μm.

The ceramic capillary membranes (1) are filled into the pipe serving as the mold (2). The fill level is in the range of 80% of the maximum fill level of the mold (2). The pipe serving as the mold (2) is closed on both sides by a nonwoven material. Then, ceramic potting compound is introduced by pouring through a bore provided at the side of the pipe serving as the mold (2) during a centrifugal process in a centrifuge. The introduced potting compound forms the closing layer (7) disposed at the module end (10). The different potting compounds, which form the different layers (4), (5), (6) of the first potting (3a), are introduced successively in a similar fashion. This means that the ceramic potting compound forming the closing layer (7) is followed by a second ceramic potting compound, which forms the exterior layer I (4). Then, the glass potting compound, which forms the intermediate layer (5), is introduced. Then, another ceramic potting compound, which forms the exterior layer II (6), is introduced. Thereafter, the potting compounds that form the second potting (3b) are introduced in a similar fashion. Each layer of the two pottings (3a) and (3b) has a minimum thickness of 1 cm.

The module (100) is sintered in the upright position for two hours at 1175 C. The closing layers are then removed by means of a diamond saw.

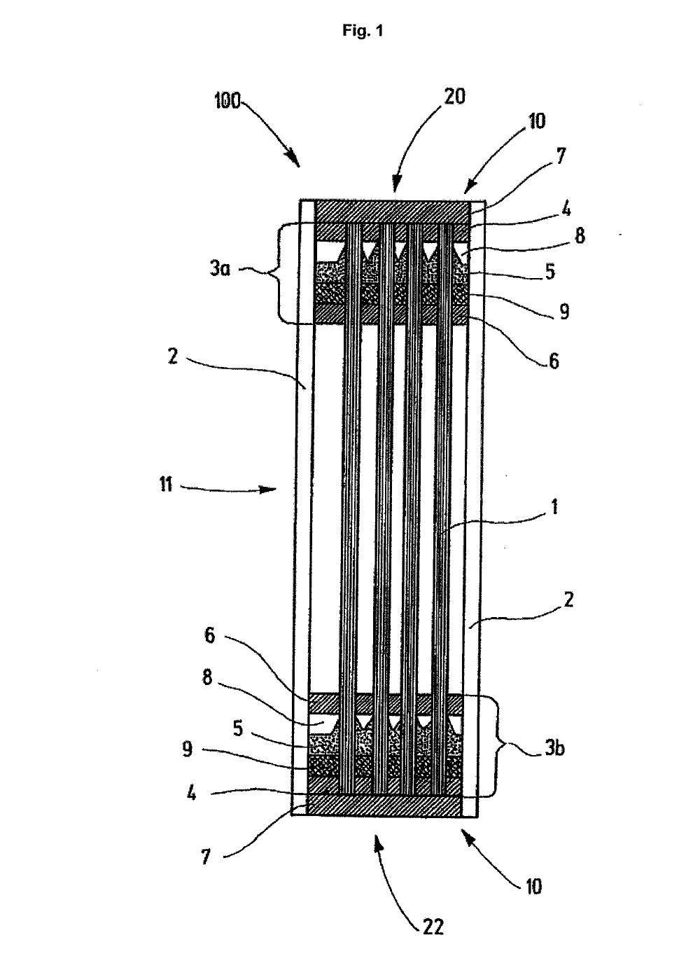

### FIG. 1

The FIGURE shows a preferred embodiment of a module (100) according to the invention. A module (100) is shown, which comprises a mold (2) as well as ceramic hollow fibers or hollow fibers comprising ceramic (1) introduced therein and two pottings (3a), (3b). In a longitudinal sectional view, the mold (2) has a rectangular shape, however it represents a tubular receptacle with a continuous hollow space viewed in the longitudinal direction. In this mold (2) configured as a hollow body, hollow fibers (1) are disposed parallel to the longitudinal direction of the mold (2) over nearly the entire length of the mold (2). The hollow fibers disposed in the longitudinal direction in the mold (2) are potted in the two end regions (20), (22) of the mold in pottings (3) in a defined peripheral longitudinal section of the hollow fiber and thereby fixed in place in the mold (2). The potting (3) provides a gas-tight seal of the lumen interior of the mold comprising the hollow fibers with respect the exterior of the mold. It is apparent from the FIGURE that the potting (3) comprises a plurality of layers having different compositions. The potting (3) comprises an exterior layer I (4) made of a ceramic material, an intermediate layer (5) made of glass or metal disposed underneath, which is to say toward the inside of the mold, and a second exterior layer (6), which is disposed the farthest from the closest end of the mold (2). The exterior layer II (6) is likewise made of a ceramic material, particularly the same ceramic material as the exterior layer I (4). The module in the example was sintered in the upright position. As a result, the following layer sequence is created. In the exterior layer II (6) disposed at the bottom of the upper potting (3a), partially molten glass or metal from the intermediate layer (5) was incorporated and accordingly, toward the top, which is to say in the direction opposite to the gravitational force or in the direction of the closest end region (20) of the mold (2), forms an incorporated layer (9) between the exterior layer II (6) and the intermediate layer (5). The incorporated glass or metal leaves behind a hollow space (8), likewise in the direction opposite to the gravitational force or in the direction of the closest end region (20) of the mold (2). This hollow space is disposed between the exterior layer I (4) and the intermediate layer (5). In the lower potting (3b), glass or metal from the intermediate layer (5) was partially incorporated in the exterior layer I (4) and accordingly likewise forms an upwardly incorporated layer (9), in this case between the exterior layer I (4) and the intermediate layer (5). Again, the incorporated glass or metal leaves behind a hollow space (8), likewise in the direction opposite to the gravitational force or opposite to the direction of the closest end region (22) of the mold (2). The hollow space (8) formed as a result of the incorporation is disposed in the lower potting (3b) between the exterior layer II (6) and the intermediate layer (5).

### Wherein:

(1) Hollow fiber or capillary membrane
(2) Mold
(3) Potting
(3a) Upper potting
(3b) Lower potting
(4) Exterior layer I
(5) Intermediate layer
(6) Exterior layer II
(7) Closure
(8) Hollow space
(9) Incorporated layer
(10) Module end
(11) Module interior
(20) Upper end region of the mold
(22) Lower end region of the mold
(100) Module

1. A module, comprising
a) a mold (2),
b) at least one hollow fiber or capillary membrane (1) introduced therein, and
c) at least one potting (3) configured as a gas-tight bond between the mold (2) and the at least one hollow fiber or capillary membrane (1),
characterized in that the potting (3) comprises at least three layers (4), (5), (6) made of at least two different potting compounds.

2. The module according to claim 1, wherein the at least one hollow fiber or capillary membrane (1) is made of a ceramic or a material comprising ceramic.

3. A module according to any one of the preceding claims, wherein at least one of the at least three layers (4), (5), (6) is made of a material that is compatible with the material of the at least one hollow fiber or capillary membrane (1).

4. The module according to claim 2, wherein at least one of the at least three layers (4), (5), (6) is made of the same ceramic or the same material comprising ceramic as the at least one hollow fiber or capillary membrane (1).

5. A module according to any one of the preceding claims, wherein the at least one potting (3) is formed by two exterior layers (4), (6) and an interposed intermediate layer (5).

6. A module according to any one of the preceding claims, wherein the at least one potting (3) comprises three layers (4), (5), (6) made of a total of three different potting compounds.

7. A module according to any one of the claims 1 to 5, wherein the at least one potting (3) comprises three layers (4), (5), (6) made of a total of two different potting compounds, the two exterior layers (4), (6) being made of the same potting compound.

8. The module according to claim 7, wherein the two exterior layers (4), (6) are made of a ceramic or a material comprising ceramic and wherein the intermediate layer (5) is made of glass.

9. The module according to claim 7, wherein the two exterior layers (4), (6) are made of a ceramic or a material comprising ceramic and wherein the intermediate layer (5) is made of metal.

10. A module according to any one of the claims 8 or 9, wherein the material softening point of the glass or metal used for the intermediate layer (5) is below the sintering temperature of the ceramic or the material comprising ceramic of the two exterior layers (4), (6) and above the operating temperature of the module.

11. A module according to any one of the claims 8 to 10, wherein the ceramic or the material comprising ceramic of the two exterior layers (4), (6) has a high wettability with respect to the glass or metal used for the intermediate layer (5).

12. A module according to any one of the claims 8 to 11, wherein, during a sintering operation, the viscosity of the glass or metal used for the intermediate layer (5) allows for the sealing of small pores and cracks in one of the two exterior layers (4 or 6).

13. A module according to any one of the preceding claims, wherein the expansion coefficient of the potting compounds of the at least three layers (4), (5), (6) is similar or identical to that of the at least one hollow fiber or capillary membrane (1).

14. A module according to any one of the preceding claims, wherein the potting compounds of the at least three layers (4), (5), (6) are chemically inert with respect to the at least one hollow fiber or capillary membrane (1).

15. A module according to any one of the preceding claims, wherein the at least one hollow fiber or capillary membrane (1) is introduced at both ends thereof in one potting (3) each.

16. A method for producing a module, particularly according to any one of the claims 1 to 15, comprising the following steps in the listed sequence:
a) introducing at least one hollow fiber or capillary membrane (1) into a mold (2),
b) introducing a first potting compound into the mold (2),
c) shaping a first layer (4) of a potting (3) from the introduced first potting compound,
d) introducing a second potting compound into the mold (2),
e) shaping a second layer of a potting (3) from the introduced second potting compound,
f) introducing a third potting compound into the mold (2), and
g) shaping a third layer (6) of a potting (3) from the introduced third potting compound.

17. The method according to claim 16, wherein at least one second potting (3) is introduced into the mold (2) and shaped.

18. A method according to any one of the claims 16 or 17, wherein the shaped layers (4), (5), (6) of the at least one potting (3) are hardened.

19. The method according to claim 18, wherein an introduced and shaped layer of the at least one potting (3) is hardened prior to introducing a further potting compound.

20. The method according to claim 18, wherein, after introducing and shaping all potting compounds, the layers of the at least one potting (3), which are formed by the potting compound, are hardened simultaneously.

21. A method according to any one of the claims 16 to 20, wherein the first and third potting compounds are made of a ceramic or a material comprising ceramic and wherein the second potting compound is made of glass or metal.

22. A method according to any one of the claims 16 to 21, wherein the materials forming the potting compound are introduced as slips.

23. The method according to claim 22, wherein the introduced slip is produced by dispersing particulate potting material in a fluid.

24. A method according to any one of the claims 16 to 23, wherein the first layer (4) of the at least one potting (3) is joined to a closure (7).

25. A method according to any one of the claims 16 to 23, wherein the potting compound of the first layer (4) of the at least one potting (3) is introduced as a closure (7).

26. A method according to any one of the claims 24 or 25, wherein the material of the closure (7) is selected from ceramic materials, materials comprising ceramic, waxes, polymers, adhesives and combinations thereof.

27. A method according to any one of the claims 24 to 26, wherein after introducing and hardening at least one layer (4), and in a preferred embodiment all layers (4), (5), (6), of the at least one potting (3) the closure (7) is removed.

28. A method according to any one of the claims 16 to 27, wherein the at least three layers (4), (5), (6) of the at least one potting (3) are shaped successively by means of a centrifugal method.

29. A method according to any one of the claims 16 to 28, wherein the at least one hollow fiber or capillary membrane (1) is introduced into a mold (2) in the unsintered state.

30. A method according to any one of the claims 16 to 28, wherein the at least one hollow fiber or capillary membrane (1) is introduced into a mold (2) in the sintered state.

31. A method according to any one of the claims 18 to 30, wherein the module is sintered in one step after all the shaped layers have been hardened.

32. A method according to any one of the claims 18 to 30, wherein the module is sintered in multiple steps after all the shaped layers have been hardened.

33. A method according to any one of the claims 31 or 32, wherein the module is sintered in the upright position.

34. A method according to any one of the claims 31 to 33, wherein the sintering temperature is equal to the material softening point of the glass or metal used for the intermediate layer (5).

35. A method according to any one of the claims 31 to 33, wherein the sintering temperature is above the material softening point of the glass or metal used for the intermediate layer (5) and below the sintering temperature of the ceramic or the material comprising ceramic of the at least one hollow fiber or capillary membrane (1).

36. A method according to any one of the claims 31 to 33, wherein the sintering temperature is equal to the sintering temperature of the at least one hollow fiber or capillary membrane (1).

37. A method according to any one of the claims 31 to 36, wherein a hollow space (8) is formed between the intermediate layer (5) and an exterior layer (4) or (6) as a result of compaction of the glass or metal used for the intermediate layer (5) brought about during sintering.

38. A method according to any one of the claims 31 to 37, wherein, as a result of the sintering operation, a portion of the glass or metal used for the intermediate layer is incorporated in the pores of a portion of the ceramic or the material comprising ceramic of an exterior layer (4) or (6).

39. A module obtained by a method according to any one of the claims 16 to 38.

40. A device comprising a module according to any one of the claims 1 to 15 or 39 and a housing.

41. A device according to claim 40, wherein the housing is configured as a metal cartridge.

42. A device according to claim 41, wherein the mold and the housing are configured to be cylindrical.
